(19) United States
(12) Patent Application Publication
(10) Pub. No.: US 2026/0177668 A1
(43) Pub. Date: Jun. 25, 2026

(54) METHOD FOR OPERATING A LIDAR SYSTEM, LIDAR SYSTEM, AND VEHICLE COMPRISING AT LEAST ONE LIDAR SYSTEM

(71) Applicant: VALEO SCHALTER UND SENSOREN GMBH, Bietigheim-Bissingen (DE)

(72) Inventors: Christoph Parl, Bietigheim-Bissingen (DE); Thorsten Beuth, Bietigheim-Bissingen (DE)

(73) Assignee: VALEO SCHALTER UND SENSOREN GMBH, Bietigheim-Bissingen (DE)

(21) Appl. No.: 18/714,567

(22) PCT Filed: Nov. 29, 2022
(86) PCT No.: PCT/EP2022/083563

§ 371 Date: May 30, 2024

(30) Foreign Application Priority Data
Nov. 30, 2021 (DE) 10 2021 131 351.1

(51) Int. Cl. G01S 7/481; G01S 17/931

(52) U.S. Cl. CPC G01S 7/4814; G01S 17/931

(57) ABSTRACT

A method for operating a lidar system for a vehicle includes transmitting at least one optical beam into a monitoring region, receiving an optical beam that has been reflected to at least one object in the monitoring region, converting the optical beam into a reception variable and ascertaining a piece of object information regarding the object that reflects the optical beam. At least one optical beam is transmitted with an intensity defined over its beam profile. The method also includes projecting at least two beam profile portions onto at least two different reception regions. The at least one optical beam is transmitted with different intensities in the at least two beam profile portions.

### TECHNICAL FIELD

The invention relates to a method for operating a lidar system, in particular a lidar system for a vehicle, wherein
at least one optical beam is transmitted into at least one monitoring region using at least one transmission device,
at least one optical beam reflected at at least one object present in the at least one monitoring region is received by at least one reception region on at least one reception device and is converted into at least one reception variable,
at least one piece of object information regarding at least one object that reflects the optical beam is ascertained from at least one reception variable.

The invention also relates to a lidar system, in particular a lidar system for a vehicle,
having at least one transmission device for transmitting optical beams into at least one monitoring region, the at least one transmission device comprising at least one beam source for creating optical beams,
having at least one reception device comprising at least one reception region for receiving optical beams reflected at objects in the at least one monitoring region and for converting received optical beams into corresponding reception variables, and having at least one evaluation device for ascertaining pieces of object information regarding at least one object that reflects optical beams from ascertained reception variables.

In addition, the invention relates to a vehicle having at least one lidar system.

### PRIOR ART

WO 2019/020591 A1 has disclosed a scanning optical detection system of a vehicle for monitoring a monitoring region with regards to objects, comprising at least one transmission apparatus having at least one light source for creating at least one optical transmission signal and having at least one diffraction unit which has a diffractive effect on the at least one transmission signal and serves to control at least one beam direction of the at least one transmission signal, at least one receiver apparatus for receiving at least one optical reception signal originating from at least one transmission signal reflected at an object, and at least one control and/or evaluation device for controlling the at least one transmission apparatus and/or the at least one receiver apparatus and/or for evaluating reception signals received by the at least one receiver apparatus.

The invention is based on the object of designing a method, a lidar system, and a vehicle of the aforementioned type, in which a detection of objects in at least one monitoring region, in particular of objects reflecting to different extents and/or objects with regions reflecting to different extents, can be improved.

### DISCLOSURE OF THE INVENTION

The object is achieved according to the invention for the method in that
at least one optical beam is transmitted with an intensity distribution that is defined over its beam profile,
at least two beam profile portions of the beam profile of the at least one optical beam are projected onto at least two adjacent reception regions, are each received by the reception regions, and are converted into respective reception variables,
the at least one optical beam being transmitted with different intensities in the at least two beam profile portions.

Optical beams with defined intensity distributions across their respective beam profile are transmitted according to the invention. At least two beam profile portions of the beam profile are transmitted with different intensities. On the side of an irradiated object, adjacent regions are irradiated by the beam profile portions with different intensities. This requires no adaptation of the transmitted powers of transmitter light sources and/or transmission optics on the part of the at least one transmission device. The reflected beam profile portions are projected on adjacent reception regions of the at least one reception device, are received by the latter, and are converted into corresponding reception variables.

Thus, different intensities in adjacent regions can be achieved with a correspondingly low technical outlay. Thus, simultaneously a weakly reflective region on the object side can be scanned using a beam profile portion with a higher intensity and an adjacent strongly reflective, in particular retroreflective, region can be scanned using a beam profile portion with a lower intensity. The higher intensity still allows the detection of even weakly reflective regions using the reception device. The lower intensity prevents strongly reflective regions leading to saturation and overexposure effects, especially crosstalk, on the part of the reception device.

The at least one optical beam can irradiate an object, in particular a region of an object, with a high-intensity beam profile portion during a measurement. The lower intensities of the adjacent beam profile portions may be sufficient to detect adjacent highly reflective regions of objects.

At least one reflected optical beam is received and converted into at least one reception variable by way of the at least one reception device. The at least one reception variable can be processed further using appropriate evaluation means, especially of the lidar system.

Advantageously, at least one reception variable can be an electrical reception variable. Electrical reception variables can be evaluated and processed further using electrical evaluation means.

At least one piece of object information regarding at least one object at which the at least one optical beam is reflected is ascertained from at least one reception variable. As pieces of object information, it is possible to ascertain distances, directions, and/or speeds of objects detected by the lidar system relative to the lidar system.

“Optical” within the context of the invention refers to visible and invisible ranges of electromagnetic beams, in particular light beams. The components labeled “optically” are accordingly suitable for use in connection with ranges of electromagnetic beams visible and invisible to humans. The optical beams can be light beams, especially laser beams, in either the visible or invisible range.

Advantageously, a laser beam can be transmitted as at least one optical beam. Laser beams can be purposefully obtained with defined intensity distributions over their beam profiles.

Advantageously, at least one optical signal, in particular a laser signal, can be transmitted as at least one optical beam. This allows the optical beam to carry additional pieces of information, in particular encoding or the like.

Advantageously, the at least one optical beam can be realized in the form of signal pulses, especially laser pulses. Signal pulses can be better assigned within the reception region.

Advantageously, the lidar system can operate according to a signal time-of-flight method. A signal time-of-flight method allows a distance to an object, where the optical beam is reflected, to be ascertained on the basis of the time-of-flight of a transmitted optical beam.

Advantageously, the lidar system can be configured as a laser-based ranging system. Laser-based ranging systems can comprise lasers, in particular diode lasers, as signal sources. Lasers can be used to transmit in particular pulsed laser beams as optical beams. Lasers can be used to emit optical beams in wavelength ranges that are visible or not visible to the human eye. Accordingly, reception regions of the lidar system may be realized using sensors designed for the wavelength of the transmitted optical beams, in particular point sensors, line sensors and/or surface sensors, in particular (avalanche) photodiodes, photodiode lines, CCD sensors, active pixel sensors, in particular CMOS sensors, or the like.

The invention can advantageously be used in vehicles, in particular motor vehicles. Advantageously, the invention can be used in land vehicles, in particular automobiles, trucks, buses, motorcycles or the like, aircraft, in particular drones, and/or watercraft. The invention can also be used in vehicles that can be operated autonomously or at least semi-autonomously. However, the invention is not restricted to vehicles. It can also be used in stationary operation, in robotics and/or in machines, in particular construction or transport machinery, such as cranes, excavators or the like.

The lidar system can advantageously be connected to at least one electronic control apparatus of a vehicle and/or a machine, in particular a driver assistance system or the like, or be part of such a control apparatus. In this way, at least some of the functions of the vehicle and/or of the machine can be performed autonomously or semi-autonomously.

The lidar system can be used to detect stationary or moving objects, in particular vehicles, people, animals, plants, obstacles, uneven driving surfaces, in particular potholes or stones, roadway boundaries, road signs, free spaces, in particular parking spaces, precipitation or the like, and/or movements and/or gestures.

In an advantageous configuration of the method,
at least one optical beam whose beam profile has an intensity distribution that is symmetric with respect to at least a beam axis can be transmitted,
and/or
at least one optical beam whose beam profile has an intensity distribution that is non-symmetric with respect to at least a beam axis can be transmitted,
and/or
at least one optical beam whose beam profile has at least three beam profile portions with different intensities can be transmitted. This allows for the creation of a suitable beam profile with an appropriately defined intensity distribution, depending on the intended use and/or configuration of the lidar system.

Advantageously, the beam profile of at least one optical beam may have a symmetric intensity distribution. Symmetric intensity distributions can be easily achieved.

In an alternative to that or in addition, the beam profile of at least one optical beam may advantageously have a non-symmetric intensity distribution. This allows for a greater number of different intensities with the corresponding beam profile portions to be achieved simultaneously.

In an alternative to that or in addition, the beam profile of at least one optical beam may advantageously have at least three beam profile portions with different intensities. This allows for the simultaneous scanning of the monitoring region using three different beam intensities. This can reduce the measurement time overall.

In a further advantageous configuration of the method, at least two optical beams can be transmitted with a time offset, in particular in succession, in different beam directions into the at least one monitoring region. This allows the at least one monitoring region to be scanned in at least two portions with the optical beams. As a result, a plurality of regions of one object or a plurality of objects in the at least one monitoring region can be detected.

A beam direction is the direction in which an optical beam is transmitted.

In a further advantageous embodiment of the method,
changes in beam directions of the at least two optical beams can be achieved using at least one beam deflection device,
and/or
changes in beam directions can be achieved in particular by the time-offset activation of at least two beam sources which are assigned different beam directions.

At least one beam deflection device can be used to deflect the beam direction of optical beams created by a signal source. This does not require a change in the alignment of the signal source.

In an alternative to that or in addition, the beam direction can be achieved by in particular a time-offset activation of beam sources with different beam directions. The beam sources can be assigned different beam directions. In the process, the beam sources themselves and/or transmission optical units in each case assigned to the beam sources can be aligned differently. In this way, the optical beams can be transmitted into the at least one monitoring region in different directions. The direction in which the at least one monitoring region is scanned by the optical beams can be modified by the time-offset activation of the beam sources.

Advantageously, at least two beam sources can be activated simultaneously. This allows for the simultaneous scanning of the monitoring region using the respective optical beams.

Advantageously, at least two beam sources can be activated with a time offset, in particular in succession, in an alternative to that or in addition. This allows for scanning of the corresponding regions of the monitoring region with a time offset, in particular in succession.

In an alternative to that or in addition, it is possible to use at least two beam sources assigned a common or a respective beam deflection device. This allows for the advantages of at least two beam sources and the advantages of a beam deflection device to be combined.

The beam deflection device can be a deflection mirror, a pivoting mirror, an oscillating mirror, in particular a micro-oscillating mirror, a diffractive optical element, or the like. Such beam deflection devices can be modified for the corresponding change in the beam direction, in particular can be inclined or pivoted relative to an optical axis of a beam source.

In a further advantageous embodiment of the method,
the direction of the transmitted at least two optical beams can be set to differ by a measure, particularly an angle, which corresponds to an integer multiple of a distance between centers of adjacent reception regions on the side of the reception regions,
and/or
the directions of the transmitted at least two optical beams can be modified by an increment which corresponds to a distance between centers of adjacent reception regions on the side of the reception regions. This allows for the at least two beam profile portions of the at least one optical beam to be projected on the respective adjacent reception regions.

In a further advantageous configuration of the method, reception variables from reception regions on which beam profile portions of the reflected at least one optical beam are projected with different intensities can be combined for the purpose of ascertaining pieces of object information. This can increase a dynamic range of the lidar system. In particular, receiver variables from reception regions on which beam profile portions with high intensities are projected can be combined with receiver variables from reception regions on which beam profiles with comparatively lower intensities are projected.

In a further advantageous embodiment of the method,
at least two adjacent reception regions on which at least two beam profile portions are projected can be read in parallel, in particular simultaneously,
and/or
at least two adjacent reception regions on which at least two beam profile portions are projected can be read in series, in particular successively,
and/or
of the at least two reception regions on which the at least two beam profile portions are projected, it can be only the reception region on which the beam profile portion with the greater intensity is projected that is read.

As a result of a parallel readout of adjacent reception regions, a correspondingly larger portion of the monitoring region can be captured simultaneously during a measurement.

As a result of the serial readout of adjacent reception regions, a processing speed used to process the reception variables can be reduced on the part of the reception device. This allows for the use of evaluation devices with a lower performance.

The amount of data to be processed can be reduced by only reading the reception region receiving the greatest intensity.

In a further advantageous configuration of the method, at least one optical beam with a defined beam profile might be transmitted, wherein the ratios of the spatial extent of the beam profile portions in a spatial direction with different intensities correspond to the ratios of the distances between the centers of the at least two reception regions. This allows for the beam profile portions to be projected on the respective reception regions, even when the beam direction of the at least one optical beam has been modified.

Further, the invention achieves the object for the lidar system in that
the at least one transmission device comprises at least one means for defining an intensity distribution in beam profiles of optical beams,
the at least one reception device comprises at least two, adjacently arranged reception regions,
the at least one reception device comprises at least one projection means for projecting at least two beam profile portions of beam profiles of optical beams onto the at least two adjacent reception regions,
with the intensity differing in beam profile portions of transmitted optical beams prior to their reflection, the beam profile portions corresponding to the at least two beam profile portions of the reflected optical beams projected onto the at least two reception regions.

According to the invention, the at least one transmission device comprises at least one means for defining an intensity distribution in beam profiles of optical beams. In this way, different intensities can be simultaneously transmitted into the at least one monitoring region using an optical beam. This allows for the realization of different intensities without this requiring a modification of the transmission power of corresponding beam sources and/or modifications of possible transmission optics.

The at least one reception device comprises at least two reception regions. The beam profile portions of reflected optical beams can be projected accordingly onto the at least two reception regions.

In one advantageous embodiment,
at least one transmission device can comprise at least one beam shaping means, particularly at least one optical lens or the like, for shaping defined beam profiles of optical beams created by the at least one beam source,
and/or
at least one transmission device can comprise a plurality of beam sources which each serve to create individual optical beams and are arranged such that the individual optical beams are combined to form optical beams with beam profiles with defined intensity distributions.

As a result of using at least one beam shaping means, only one beam source is required for the creation of a corresponding beam profile.

In an alternative to that or in addition, provision can be made for a plurality of beam sources. The beam sources may have individual beam profiles. The individual beams with the respective beam profiles can be combined, and so a single optical beam with a desired beam profile with a defined intensity distribution arises. This allows for the spatial extent of the optical beam to be increased. Thus, a larger portion of the monitoring region can be scanned by the optical beam.

Advantageously, the beam sources may be assigned different beam directions. This allows for simultaneous scanning, or sweeping, of a larger portion of the at least one monitoring region using optical beams.

In a further advantageous embodiment at least one transmission device can comprise at least one beam deflection device, in particular at least one deflection mirror, at least one pivoting mirror, at least one oscillating mirror, and/or at least one diffractive optical element or the like. This allows for the beam direction of the optical beams to be modified. Thus, the at least one monitoring region can be scanned accordingly by optical beams.

The object is also achieved for the vehicle according to the invention in that the vehicle has at least one lidar system according to the invention.

According to the invention, the vehicle comprises at least one lidar system according to the invention, which can be used to monitor at least one monitoring region in a surround and/or an interior of the vehicle, in particular for objects.

Advantageously, the vehicle can have at least one driver assistance system. With the aid of a driver assistance system, at least some of the functions of the vehicle, especially driving functions, can be operated autonomously or partially autonomously.

Advantageously, at least one lidar system can be functionally connected to at least one driver assistance system of the vehicle. This allows for pieces of information about the monitoring region, in particular about objects in the monitoring region ascertained by the at least one lidar system, to be used by the at least one driver assistance system for autonomous or semi-autonomous operation of the vehicle.

Moreover, the features and advantages indicated in connection with the method according to the invention, the lidar system according to the invention and the vehicle according to the invention, and the respective advantageous configurations thereof, apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider individually the features that have been disclosed in combination in the drawing, the description and the claims and will combine them to form meaningful further combinations. In the drawing, schematically,

FIG. 1 shows a front view of an automobile having a driver assistance system and a lidar system for monitoring a monitoring region in front of the automobile in the direction of travel;

FIG. 2 shows a functional representation of the lidar system and driver assistance system from FIG. 1;

FIG. 3 shows a beam profile of an optical beam transmitted by a transmission device of the lidar system from FIG. 2;

FIG. 4 shows an intensity distribution along the beam profile of the optical beam from FIG. 3, according to a first exemplary embodiment;

FIG. 5 shows a front view of a receiver of a reception device of the lidar system from FIG. 2, for receiving the reflected optical beam from FIG. 4;

FIG. 6 shows the intensity distributions of three optical beams, each with an intensity distribution according to FIG. 4, which are successively transmitted into the monitoring region in directions that were modified by a defined measure;

FIG. 7 shows the front view of the receiver from FIG. 5, for receiving the reflected optical beams from FIG. 6;

FIG. 8 shows the intensity distributions of three optical beams according to a second exemplary embodiment, each with an asymmetric intensity distribution, which are successively transmitted into the monitoring region in directions that were modified by a defined measure;

FIG. 9 shows the front view of the receiver from FIG. 5, for receiving the reflected optical beams from FIG. 8;

FIG. 10 shows a front view of a laser arrangement with three adjacently arranged lasers of a transmission device according to a third exemplary embodiment of the lidar system from FIGS. 1 and 2;

FIG. 11 shows a beam profile of an optical beam created by the laser arrangement from FIG. 10, the optical beam being assembled from the individual optical beams created by the three lasers;

FIG. 12 shows an intensity distribution of the beam profile of the optical beam from FIG. 11;

FIG. 13 shows the front view of the receiver from FIG. 7, for receiving the reflected optical beam from FIGS. 11 and 12.

In the figures, identical components are provided with identical reference signs.

### Embodiment(s) of the Invention

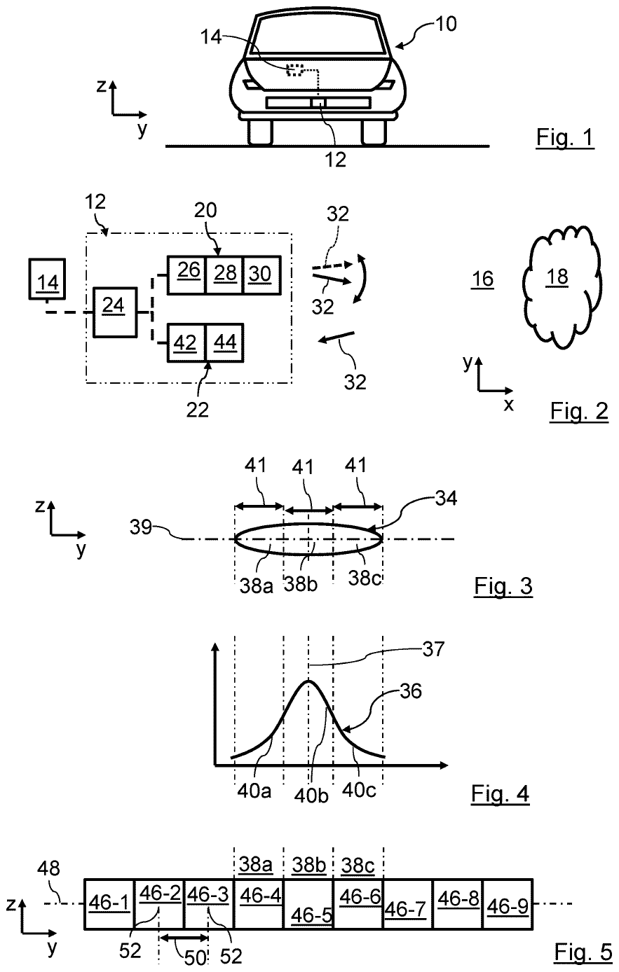

FIG. 1 shows the front view of a vehicle 10 in the form of an automobile. The vehicle 10 comprises a lidar system 12 and a driver assistance system 14. The lidar system 12 and the driver assistance system 14 are shown in a functional representation in FIG. 2.

The lidar system 12 is situated by way of example in the front fender of the vehicle 10 and is directed into a monitoring region 16 in the direction of travel in front of the vehicle 10. The lidar system 12 may also be arranged with a different alignment in a different position on the vehicle 10. The vehicle 10 may also comprise a plurality of lidar systems 12 that may have different alignments.

The lidar system 12 is functionally connected to the driver assistance system 14. The connection can be used to transfer pieces of information about the monitoring region 16 obtainable by the lidar system 12 to the driver assistance system 14. The driver assistance system 14 can be used to operate the vehicle 10 autonomously or semi-autonomously.

Objects 18 situated in the monitoring region 16 can be detected using the lidar system 12. It is possible to obtain pieces of information about objects 18, for example distances, directions, and/or speeds of detected objects 18 relative to the lidar system 12, i.e., relative to the vehicle 10.

The lidar system 12 can be used to detect stationary or moving objects 18, for example vehicles, persons, animals, plants, obstacles, uneven driving surfaces, for example potholes or rocks, roadway boundaries, road signs, free spaces, in particular parking spaces, precipitation or the like, and/or movements of objects 18 and/or gestures. FIG. 2 shows an object 18 by way of example.

For better orientation, the corresponding coordinate axes of a Cartesian xyz-coordinate system are shown in some of the figures. In the exemplary embodiments shown, the x-axis for example extends parallel to a vehicle longitudinal axis of the motor vehicle 10, the y-axis extends parallel to a vehicle transverse axis, and the z-axis extends perpendicular to the xy-plane spatially upward. When the motor vehicle 10 is in operation on a horizontal roadway, the x-axis and the y-axis extend spatially horizontally and the z-axis extends spatially vertically.

FIG. 2 shows the lidar system 12 and the exemplary object 18 in a plan view from above, as viewed against the z-axis. The illustration is not to scale.

The lidar system 12 comprises a transmission device 20, a reception device 22, and a control and evaluation device 24.

The transmission device 20 comprises an optical beam source in the form of a laser 26, a beam shaping means in the form of a transmission lens 28, and a beam deflection device 32, for example in the form of a pivoting mirror. The laser 26 and the beam deflection device 32 are connected in a controllable manner to the control and evaluation device 24.

The laser 26 can be used to create optical beams 32 in the form of laser pulses and transmit these in the direction of the transmission lens 28.

The beam profile of the optical beams 32 can be shaped into a beam profile 34 with a defined intensity distribution 36 using the transmission lens 28.

FIG. 3 shows an elliptical beam profile 34 of an optical beam 32 according to a first exemplary embodiment by way of example. The associated intensity distribution 36 is shown in FIG. 4. The intensity distribution 36 is symmetric with respect to a beam axis 37 and approximately has the shape of a Gaussian curve. By way of example, the beam axis 37 runs perpendicular to the beam direction of the optical beam 32, approximately parallel to the z-axis in exemplary fashion. By way of example, the beam direction is the main propagation direction of the optical beam 32.

By way of example, the beam profile 34 has three beam profile portions 38, specifically 38a, 38 b, and 38 c, with respective intensities 40, specifically 40 a, 40 b, and 44c.

The beam profile portions 38a, 38b, and 38c are arranged adjacently along an imaginary beam profile axis 39 of the beam profile 34. The beam profile axis 39 extends perpendicular to the beam direction of the optical beam 32, parallel to the xy-plane and perpendicular to the beam axis 37 by way of example. The extents 41 of the beam profile portions 38a, 38b and 38c are identical in the direction of the beam profile axis 39.

The beam profile portion 38b is located in the center of the beam profile 34 and comprises the maximum of the intensity distribution 36. The two beam profile portions 38a and 38c lie symmetrically on opposite sides of the central beam profile portion 38b. The intensities 40a and 40c of the optical beam 32 in the two outer beam profile portions 38a and 38c are the same and in each case greater than the intensity 40b in the central beam profile portion 38b.

The optical beams 32 with the defined beam profile 34 can be transmitted to the beam deflection device 30 by the transmission lens 28. The beam directions of the optical beams 32 can be set by way of the beam deflection device 30. Thus, the optical beams 32 with the respective beam direction can be steered into the monitoring region 16.

For example, the beam deflection device 30 can be controlled using the control and evaluation device 24, in order to set the beam direction of the optical beams 32 in the monitoring region 16. This allows for pivoting of the beam direction of the optical beams 32 in the monitoring region 16 by way of an appropriate control of the beam deflection device 30, and hence said monitoring region can be scanned using the optical beams 32. By way of example, the beam deflection device 30 can be designed such that it can be used to pivot the beam directions of the optical beams 32 in a plane, for example parallel to the xy-plane, a normal operational orientation of the vehicle 10 in the horizontal.

The optical beams 32 incident at of the object 18 might be reflected by the object 18. The optical beams 32 reflected in the direction of the reception device 22 can be received by the reception device 22. The intensity of the optical beams 32 changes depending on the reflectivity of the reflecting location on the object 18.

The reception device 22 comprises a receiver 42 and an optical projection means in the form of a reception lens 44.

As viewed from the monitoring region 16, the reception lens 44 is arranged in front of the receiver 42. The reception lens 44 can be used to project optical beams 32 reflected in the monitoring region 16 onto the receiver 42.

The receiver 42 according to a first exemplary embodiment is shown in FIG. 5 in a front view with an observation direction parallel to the x-axis. By way of example, the receiver 42 is realized as a photodiode line. By way of example, the receiver 42 comprises nine pixels, which each form optical reception regions 46 for optical beams 32. To aid distinguishability, the reception regions 46 are labeled 46-1 to 46-9. By way of the receiver 34, it is possible to convert respective optical beams 32 incident on the reception regions 46 into electrical reception variables, for example electrical reception signals.

The receiver 42 is functionally connected to the control and evaluation device 24. The control and evaluation device 24 can be used to control the receiver 42 and evaluate pieces of information ascertained by the receiver 42, for example the electrical reception variables.

The reception regions 46 are arranged adjacently in a row along an imaginary receiver axis 48. By way of example, the reception region axis 48 extends parallel to the y-axis and perpendicular to the x-axis. The distances 50 between the centers 52 of adjacent reception regions 46 are identical by way of example.

The reception lens 44 allows the incident optical beams 32 to be projected directionally dependently onto the reception regions 46. A direction from which the optical beams 32 originate, i.e., a direction in which the reflective object 18 is situated relative to the lidar system 12, can be ascertained from the positions of the illuminated reception regions 46 within the photodiode line of the receiver 42.

Both the distances 50 between the centers 52 of the reception regions 46 and the extents 41 of the beam profile portions 38 are identical in each case. Therefore, the ratios of the distances 50 between the centers 52 among themselves and the ratios of the extents 41 of the beam profile portions 38 among themselves are also identical, in each case equal to 1 in the exemplary embodiment.

Thus, the reception lens 44 is matched to the receiver 42 in such a way that the extents 41 of the beam profile portions 38 of the reflected optical beams 32, which are projected onto the reception regions 46, correspond to the distances 50 between the centers 52. Thus, the three beam profile portions 38a, 38b, and 38c can each be projected onto one of three adjacent reception regions 46, for example on the reception regions 46-4, 46-5, and 46-6 in FIG. 5.

The respective beam profile portions 38 can each be shifted to a different reception region 46 when the beam direction of the reflected optical beams 32 is modified by an angle that brings about a shift of the beam profile 34 projected onto the reception regions 46 by the value of the distance 50 between the centers 52 or by an integer multiple of the value of the distance 50 along the receiver axis 48.

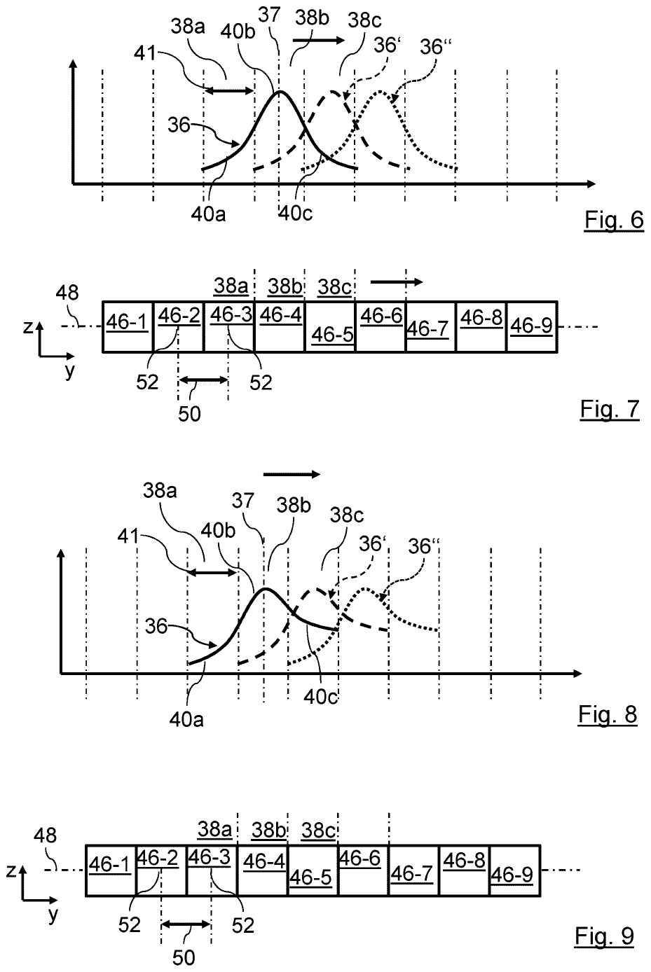

FIG. 6 shows the intensity distributions 36 of the beam profiles 34 of three optical beams 32 during three measurements by way of example. FIG. 7 shows the corresponding reception regions 46 of the receiver 42. During each measurement, the beam direction of the optical beams 32 was altered by an angle, resulting in a shift of the beam profile 32 projected onto the reception regions 46 by the distance 50. As a consequence, the beam profile portions 38a, 38b, and 38c each migrate to the adjacent reception regions 46 from one measurement to the next.

During the first measurement with the intensity distribution 36 depicted by the solid line, the intensity 40a of the beam profile portion 38a is received by the reception region 46-3 by way of example. The maximum intensity 40b of the beam profile portion 38b is received by the adjacent reception region 46-4 and the intensity 40c of the beam profile portion 38c is received by the reception region 46-5. The reception regions 46 are read out simultaneously, and so the beam profile portions 38a, 38b, and 38c reflected by the respective locations on the object 18 are detected simultaneously by way of the corresponding reception regions 46-3, 46-4, and 46-5.

During the second measurement with the intensity distribution 36′depicted by the dashed line, the intensity 40a of the beam profile portion 38a is received, by way of example, by the reception region 46-4, the maximum intensity 40b of the beam profile portion 38b is received by the adjacent reception region 46-5, and the intensity 40c of the beam profile portion 38c is received by the reception region 46-6.

During the third measurement with the intensity distribution 36″ depicted by the dotted line, the intensity 40a of the beam profile portion 38a is received, by way of example, by the reception region 46-5, the maximum intensity 40b of the beam profile portion 38b is received by the adjacent reception region 46-6, and the intensity 40c of the beam profile portion 38c is received by the reception region 46-7.

Overall, the locations on the object 18 at which the respective beam profile portions 38a, 38b, and 38c are reflected in accordance with the beam direction of the transmitted optical beams 32 during the respective measurement are scanned with two different intensities 40, specifically 40a and 40c on the one hand and 40b on the other hand, during the three measurements. This requires no modification of the transmission lens 28 and/or of the transmission power of the laser 26. Thus, weakly reflecting locations of the object 18 can be captured using the high intensity 40b of the second beam profile portion 38b and strongly reflecting locations, for example retroreflective locations, of the object 18, which would lead to a crosstalk between the reception regions 46 in the case of intensities that are high, can be captured using the lower intensities 40a and 40b of the first beam profile portion 38a and the third beam profile portion 38c. Overall, this can increase the dynamic range of the lidar system 12 in relation to the reflectivity of detectable objects 18.

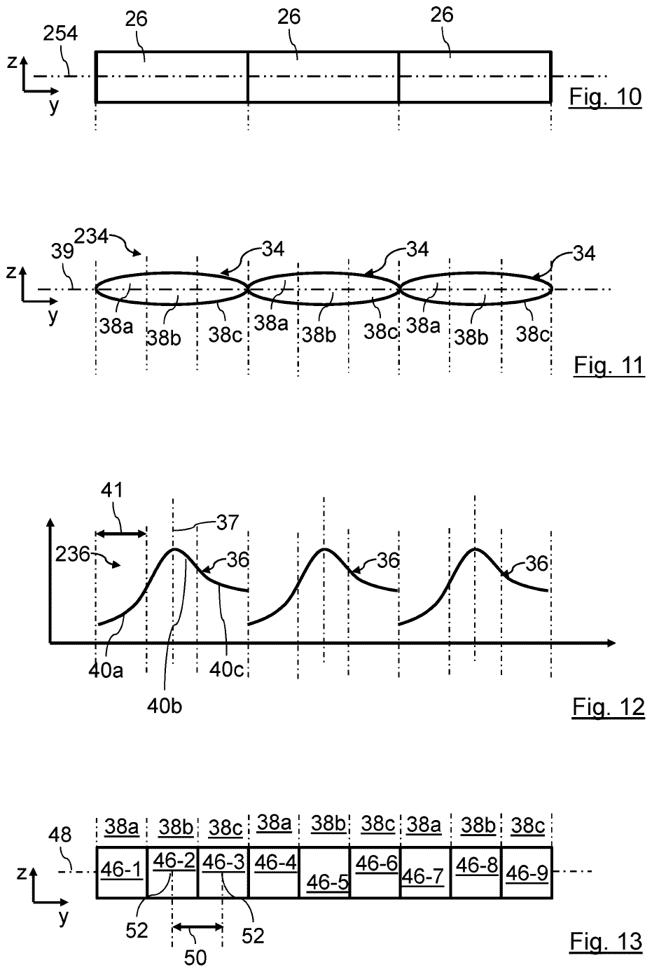

FIG. 8 shows an intensity distribution 36 of a beam profile 34 of optical beams 32 according to a second exemplary embodiment. FIG. 9 accordingly shows the receiver 42. Those elements which are similar to those of the first exemplary embodiment from FIGS. 3 to 7 are provided with the same reference signs. The second exemplary embodiment differs from the first exemplary embodiment in that the intensity distribution 36 of the beam profile 34 of the optical beams 32 is non-symmetric with respect to the beam axis 37. The intensity 40a of the first beam profile portion 38a is lower than the intensity 40c of the third beam profile portion 38c. This allows for three beam profile portions 38 with three different intensities 40 to be realized within the beam profile 34. Thus, appropriate pivoting of the beam direction of the optical beams 32 allows the locations on the object 18 to be successively scanned using three different intensities 40a, 40b, and 40c.

FIG. 10 shows an arrangement of three lasers 26 of a transmission device 20 of a lidar system 12 according to a third exemplary embodiment. FIG. 11 shows a beam profile 234 of an optical beam 32 which is assembled from the individual beam profiles 34 of optical beams generated by the lasers 26. FIG. 12 shows the intensity distribution 236 of the beam profile 234. The individual intensity distributions 36 of the individual beam profiles 34 correspond to the asymmetric intensity distribution 36 of the beam profile 34 from the second exemplary embodiment in FIG. 8.

The three lasers 26 are arranged adjacently along an imaginary transmitter transverse axis 254. By way of example, the transmitter transverse axis 254 runs parallel to the receiver axis 48 of the receiver 42. The receiver 42 is shown in FIG. 13.

The lasers 26 and their respective transmission lenses 28 (not shown in FIG. 10) are matched to one another in such a way that the beam profile portions 38 of the adjacent individual beam profiles 34 adjoin one another. For example, the first beam profile portion 38a of the second individual beam profile 34, in the center of FIG. 12, adjoins the third beam profile portion 38c of the first individual beam profile 34, to the left of FIG. 12. In this way, a larger spatial region is scanned simultaneously using the assembled beam profile 234. All nine reception regions 46 of the receiver 42 are covered at the same time by the beam profile 234 of the reflected optical beams 32.

1. A method for operating a lidar system for a vehicle, the method comprising:
transmitting at least one optical beam into at least one monitoring region using at least one transmission device,
receiving at least one optical beam that has been reflected to at least one object present in the at least one monitoring region using at least one reception region on at least one reception device and converting the optical beam into at least one reception variable,
ascertaining at least one piece of object information regarding at least one object that reflects the optical beam from at least one reception variable,
wherein at least one optical beam is transmitted with an intensity distribution that is defined over its beam profile,
projecting at least two beam profile portions of the beam profile of the at least one optical beam onto at least two adjacent reception regions, receiving each beam profile portion with the reception regions, and converting each beam profile portion respective reception variables,
wherein the at least one optical beam is transmitted with different intensities in the at least two beam profile portions.

2. The method as claimed in claim 1,
the method further comprising transmitting at least one optical beam whose beam profile has:
an intensity distribution that is symmetric with respect to at least a beam axis,
an intensity distribution that is non-symmetric with respect to at least a beam axis,
or
at least three beam profile portions with different intensities.

3. The method as claimed in claim 1,
wherein at least two optical beams are transmitted in succession, in different beam directions into the at least one monitoring region.

4. The method as claimed in claim 3,
wherein changes in beam directions of the at least two optical beams are achieved using at least one beam deflection device, or
by the time-offset activation of at least two beam sources which are assigned different beam directions.

5. The method as claimed in claim 3,
wherein the directions of the transmitted at least two optical beams are set to differ by an angle, which corresponds to an integer multiple of a distance between centers of adjacent reception regions on the side of the reception regions,
and
wherein the directions of the transmitted at least two optical beams are modified by an increment which corresponds to a distance between centers of adjacent reception regions on the side of the reception regions.

6. The method as claimed in claim 1,
wherein reception variables from reception regions on which beam profile portions of the reflected at least one optical beam are projected with different intensities are combined for the purpose of ascertaining pieces of object information.

7. The method as claimed in claim 1,
wherein at least two adjacent reception regions on which at least two beam profile portions are projected are read simultaneously or successively,
and
wherein of the at least two reception regions on which the at least two beam profile portions are projected, it is only the reception region on which the beam profile portion with the greater intensity is projected that is read.

8. The method as claimed in claim 1,
the method further comprising transmitting at least one optical beam with a defined beam profile,
wherein the ratios of the spatial extent of the beam profile portions in a spatial direction with different intensities correspond to the ratios of the distances between the centers of the at least two reception regions.

9. A lidar system for a vehicle, the lidar system comprising:
at least one transmission device for transmitting optical beams into at least one monitoring region,
the at least one transmission device comprising at least one beam source for creating optical beams,
at least one reception device comprising at least one reception region for receiving optical beams reflected at objects in the at least one monitoring region and for converting received optical beams into corresponding reception variables,
and at least one evaluation device for ascertaining pieces of object information regarding at least one object that reflects optical beams from ascertained reception variables,
wherein the at least one transmission device comprises at least one means for defining an intensity distribution in beam profiles of optical beams,
wherein the at least one reception device comprises at least two, adjacently arranged reception regions,
wherein the at least one reception device comprises at least one projection means for projecting at least two beam profile portions of beam profiles of optical beams onto the at least two adjacent reception regions,
wherein, the intensity of the beam profile portions of transmitted optical beams differs prior to their reflection,
wherein the beam profile portions correspond to the at least two beam profile portions of the reflected optical beams projected onto the at least two reception regions.

10. The lidar system as claimed in claim 9,
wherein at least one transmission device at least one optical lens, for shaping defined beam profiles of optical beams created by the at least one beam source,
or
wherein at least one transmission device comprises a plurality of beam sources which each serve to create individual optical beams and are arranged such that the individual optical beams are combined to form optical beams with beam profiles with defined intensity distributions.

11. The lidar system as claimed in claim 9,
wherein at least one transmission device comprises at least one deflection mirror, at least one pivoting mirror, at least one oscillating mirror, or at least one diffractive optical element.

12. A vehicle comprising at least one lidar system wherein the vehicle comprises at least one lidar system as claimed in claim 9.
